(19) United States
(12) Patent Application Publication
(10) Pub. No.: US 2008/0046858 A1
(43) Pub. Date: Feb. 21, 2008

(54) METHOD AND APPARATUS FOR MERGE CONDITION DETECTION

(75) Inventors: Tobin MCCLEAN, Ottawa (CA); John HOGG, Kanata (CA); Tim MCGUIRE, Ottawa (CA); Mark HERMELING, Otawa (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, US

(73) Assignee: ZELIGSOFT INC., Gatineau (CA)

(21) Appl. No.: 11/833,723

(22) Filed: Aug. 3, 2007

Related U.S. Application Data
(60) Provisional application No. 60/822,410, filed on Aug. 15, 2006.

(51) Int. Cl. G06F 9/44

(52) U.S. Cl. 717/100

(57) ABSTRACT

A method and apparatus are provided for merge avoidance for a user-modifiable artifact generated by an iterative software process in a computing environment. The user-modifiable artifact may be modified many times by the user and/or by a change in the generated artifact. Current and previous generated artifacts are compared with the user-modifiable artifact. A merge condition is detected and a merge artifact are generated only in response to determination that the current and previous generated artifacts differ and that the user-modifiable artifact has been modified after generation. Merge steps, which can include an automatic or manual merge operation, can be performed in response to generation of the merge artifact. This process can be described as a method of integrating changes to an artifact generated from a software process and modified outside of the software process.

### CROSS REFERENCE TO RELATED APPLICATIONS

This application claims the benefit of priority of U.S. Provisional Patent Application No. 60/822,410 filed Aug. 15, 2006, which is incorporated herein by reference.

### FIELD OF THE INVENTION

The present invention relates generally to computer software development. More particularly, the present invention relates to software processes, which can include models, used to generate artifacts.

### BACKGROUND OF THE INVENTION

As computer software development becomes more complex, models are increasingly used by software developers. Models can be created using a Unified Modeling Language (UML), for example. Model-Driven Architecture (MDA) tools generate source code and other artifacts, using a model of the software as a basis for source code generation. An artifact can generally be described as a tangible byproduct produced during the development of software, and can include a standalone software component that can be run on a computer. Examples of artifacts include, but are not limited to: code (e.g. Java, C++); build makefiles; component descriptors; documentation; and models.

After artifacts have been generated by a MDA tool, a user can then modify some of these artifacts. However, software development is an iterative process. Tool users modify the source models (or other source artifacts) and regenerate source code. In fact, a user can concurrently modify a model and a generated artifact created by that model.

According to one known approach, the code and makefiles are generated to a build environment directory that is set in the system environment variables. An exemplary structure of the build directory is shown in FIG. 1. In a directory called “build”, a plurality of artifacts 10 are provided. In the example of FIG. 1, these artifacts 10 are generated by a MDA tool based on a software model, and can be modified by a user. If the model used to generate the artifacts 10 is changed, any user modifications to the artifacts 10 will be overwritten when the artifact is regenerated from the model.

This modification can create other problems. For example, modifying a file outside of the generation process creates a permanent need to maintain these changes through every differing generation from the automated artifact source. Also, conflicts can occur if a model and an artifact generated by that model are concurrently modified. Such conflicts can be managed by performing a merge operation.

Merging of changed textual files can be relatively straightforward, but only if both versions of the file are available. Conventional approaches to code generation have the user change the generated file. As a result, regeneration overwrites all subsequent hand modification. This leaves no indication that merging is required and nothing to merge.

Another approach is described in United States Patent Application Publication No. 2005/0262485 published on Nov. 24, 2005 and entitled “Duplicate Merge Avoidance in Parallel Development of Interdependent Semi-Derived Artifacts”. This approach independently keeps track of model and source changes using multiple versions of the source and multiple versions of the model, creating a version when a change occurs. The approach only seeks to avoid duplicates and conflicts when performing a merge, and assumes that a merge is performed when there is a modification of the model or the source.

Known approaches still do not adequately resolve the following issues: How can the user know that merging of changes from generated and altered artifacts will be needed? How can the user easily make the required merges?

It is, therefore, desirable to provide a technique for minimizing merge operations in a software build process.

### SUMMARY OF THE INVENTION

It is an object of the present invention to obviate or mitigate at least one disadvantage of previous software development processes in which a merge function may be performed.

The process described herein detects the need for a merge resulting from a (manual) post-generation change to an artifact at any preceding time.

In a first aspect, the present invention provides a method of detecting a merge condition for a user-modifiable artifact generated by an iterative software process in a computing environment. The method includes the following steps: receiving a current generated artifact as an output of a current iteration of the process; determining whether the current generated artifact differs from a previous generated artifact by comparing the current and previous generated artifacts, the previous generated artifact being generated from a previous iteration of the process; determining whether the user-modifiable artifact has been modified after generation by comparing the user-modifiable artifact with the previous generated artifact; identifying a merge condition and generating a merge artifact only in response to determination that the current and previous generated artifacts differ and that the user-modifiable artifact has been modified after generation.

A merge operation can automatically be performed in response to detection that no merge conflict exists, the merge operation being performed using the merge artifact and the user-modifiable artifact to create an updated user-modifiable artifact. Alternatively, a user can be alerted to manually perform a merge operation in response to detection that a merge conflict exists. The merge artifact can be deleted after a merge operation has been performed.

Generating the merge artifact can include copying the contents of the current generated artifact to the merge artifact. The current generated artifact can be deleted after the current iteration of the process, and the previous generated artifact can persist after the current iteration of the process. In response to determination that the current and previous generated artifacts differ, the previous generated artifact can be updated to comprise the contents of the current generated artifact. In response to determination that the current and previous generated artifacts differ but the artifact has not been modified after generation, the user-modifiable artifact can be updated to comprise the contents of the current generated artifact.

If the previous generated artifact does not exist, it can be generated based on the current generated artifact. If the user-modifiable artifact does not exist, it can be generated based on the current generated artifact. The user-modifiable artifact, the current generated artifact, the previous generated artifact and the merge artifact can be software artifacts, such as software code or a model.

In another aspect, the present invention provides a computer-readable medium storing statements and instructions which, when executed, cause a processor to perform a method of detecting a merge condition for a user-modifiable artifact in a computing environment. The user-modifiable artifact is generated by an iterative software process. The method performed by the processor can include steps and features as described above in relation to the methods according to embodiments of the present invention.

In a further aspect, the present invention provides an apparatus for detecting a merge condition for a user-modifiable artifact in a computing environment. The apparatus, or merge condition detector, is for detecting a user-modifiable artifact in a computing environment, the user-modifiable artifact being generated by an iterative software process. The apparatus includes a generated artifact comparator, a user artifact comparator and a merge analyzer. The generated artifact comparator determines whether current and previous generated artifacts differ by comparing the current generated artifact with the previous generated artifact. The current generated artifact is received as an output of a current iteration of the process and the previous generated artifact is generated by an output of a previous iteration of the process. The user artifact comparator determines whether the user-modifiable artifact has been modified after generation by comparing the user-modifiable artifact with the previous generated artifact. The merge analyzer identifies a merge condition and generates a merge artifact only in response to determination that the current and previous generated artifacts differ and that the user-modifiable artifact has been modified after generation.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a known build directory structure;

FIGS. 2A-2C illustrate contents of two storage locations during a first iteration of a software process according to an embodiment of the present invention;

FIG. 3 is a flowchart of a method of detecting a merge condition for an artifact generated by an iterative software process in a computing environment according to an embodiment of the present invention;

FIGS. 4A and 4B illustrate artifacts according to an embodiment of the present invention in the case where current and previous generated artifacts do not differ;

FIGS. 5A and 5B illustrate artifacts according to an embodiment of the present invention in the case where current and previous generated artifacts differ, but a user-modifiable artifact has not been modified after generation;

FIGS. 6A, 6B and 6C illustrate artifacts according to an embodiment of the present invention in the case where current and previous generated artifacts differ and a user-modifiable artifact has been modified after generation; and

FIG. 7 illustrates an apparatus for detecting a merge condition according to an embodiment of the present invention.

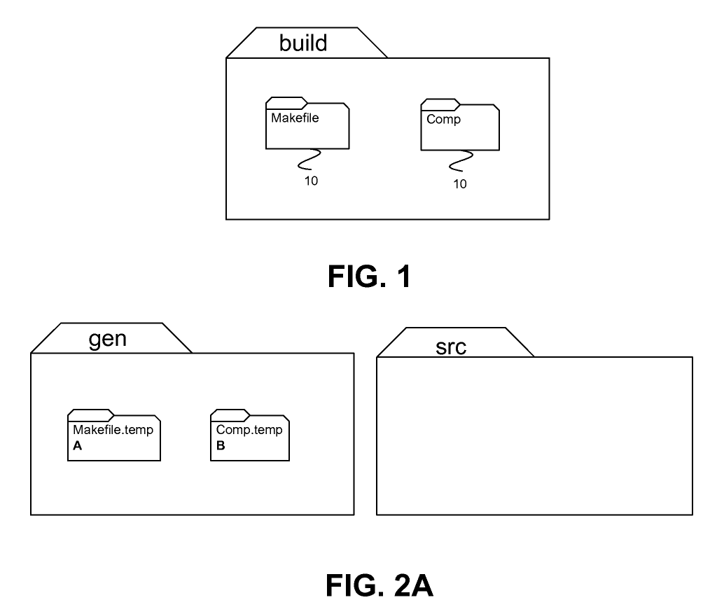

### DETAILED DESCRIPTION

Generally, the present invention provides a method and apparatus for merge avoidance for a user-modifiable artifact generated by an iterative software process in a computing environment. The user-modifiable artifact may be modified many times by the user and/or by a change in the generated artifact. Current and previous generated artifacts are compared with the user-modifiable artifact. A merge condition is detected and a merge artifact are generated only in response to determination that the current and previous generated artifacts differ and that the user-modifiable artifact has been modified after generation. Merge steps, which can include an automatic or manual merge operation, can be performed in response to generation of the merge artifact. This process can be described as a method of integrating changes to an artifact generated from a software process and modified outside of the software process.

In addition to a user-modifiable artifact automatically generated by a software process, embodiments of the present invention create current and previous generated artifacts corresponding to generation of an artifact in the current and prior iterations of the software process. Known approaches may keep a single “generated” version in addition to the user-modifiable artifact, but two such copies are used to perform the change impact analysis described herein.

The term “artifact” as used herein represents a tangible byproduct produced during the development of software, and can include a standalone software component that can be run on a computer. Examples of artifacts include, but are not limited to: code (e.g. Java, C++); build makefiles; component descriptors; documentation; and models.

The term “user-modifiable artifact” as used herein represents an artifact produced as an output of an iteration of a software process in a computing environment. The software process can be described as including an artifact generation portion that generates artifacts. The user-modifiable artifact is the artifact that is produced by the software process, and would be present without using embodiments of the present invention. This artifact can be viewed and modified by the user, and is most similar to the artifacts generated in a “build” directory, as described earlier in relation to a known approach. In an embodiment, the artifact generation portion is a model transformation engine that can produce a model as the user-modifiable artifact.

The terms “.temp file” and “current generated artifact” as used herein represent a file generated from a current iteration of a software process, and can be described as an output of the process. A .temp file is used by embodiments of the present invention to determine if a merge is necessary, and is not manipulated by the user. A .temp file used to determine whether the generated artifact has changed. In a model-based environment, this can be described as determining whether the model has changed. A .temp file has a lifespan of less than the process iteration.

The terms “.gen file” and “previous generated artifact” as used herein represent a file generated from a previous iteration of a software process, and can be described as an output of the process. The previous iteration can be the last or preceding iteration of a software process during which a generated artifact was changed. The previous iteration can be the same iteration of the process used to generate the user-modifiable artifact. A .gen file persists after the current iteration of the software process. It is used by embodiments of the present invention to determine if a merge is necessary, and is not manipulated by the user. A .gen file is compared to a .temp file to determine whether a generated artifact has changed. A .gen file is compared to a user-modifiable artifact to determine whether the artifact has been modified after generation. In a model-based environment, these comparisons can be described as determining whether a model change and/or a source change has occurred. At the end of a process iteration, the .gen file always includes the most current artifacts, and when actually realized on a disk is the version written when the file was last changed. In an embodiment, the .gen file is updated, or modified, in response to detection of a change in the generated artifact.

According to an embodiment of the present invention, a merge condition is identified and a merge artifact is created only in response to determination that the generated artifact has changed and that the user-modifiable artifact has been modified after generation. The terms “.merge file” and “merge artifact” as used herein represents such a merge artifact that is user-accessible. Optionally, in response to merge file creation, a merge can automatically be performed, or the user can be alerted of the need to merge, and can use the .merge file to merge with the user-modifiable artifact. Once the merge has been performed, the .merge file is deleted. Merge functions are well known in the art, and embodiments of the present invention can be used with any number of such functions, without requiring modification depending on the particular merge function used.

The .gen files and .temp files can be described as “process-supporting files”, which are not manipulated by the user, and are stored in order to determine the conditions under which a merge should be performed. The .gen, .temp and .merge files are artifacts, but will also be referred to non-restrictively herein as files in order to facilitate their distinction from the user-modifiable artifacts that are natural outputs of the software processes.

In an embodiment, the user-modifiable artifacts (and therefore the .gen, .temp and .merge files) are software artifacts, such as code generation artifacts generated from a software model, for example in a model-driven development tool. However, the artifacts as described herein can be generated by any iterative software process. For example, the artifacts can be generated by a software process in an automated weather station.

The artifacts and files described above can be stored in a computer-readable memory. In one embodiment, the .temp and .gen files not manipulated by the user, and the .merge files and user-modifiable artifact are all stored in the same directory structure, with each file or artifact having properties defining view/read/write permissions.

In another embodiment, .temp and .gen files are stored in a first location, and .merge files and user-modifiable artifacts are stored in a second location. These locations can be in the same directory structure, or in different directory structures. In an exemplary embodiment, user-modifiable artifacts and merge files are stored in a source directory (src), which is user-accessible. The .temp and .gen files are stored in a generation directory (gen), which is not manipulated by the user, and properties can be set to make this directory selectively viewable and/or inaccessible to the user, if desired.

While examples will be described in relation to the src and gen directory structures, it will be evident to one of ordinary skill in the art that this is only an example, and that the files and artifacts can be stored according to any of the schemes described above, or any other suitable scheme.

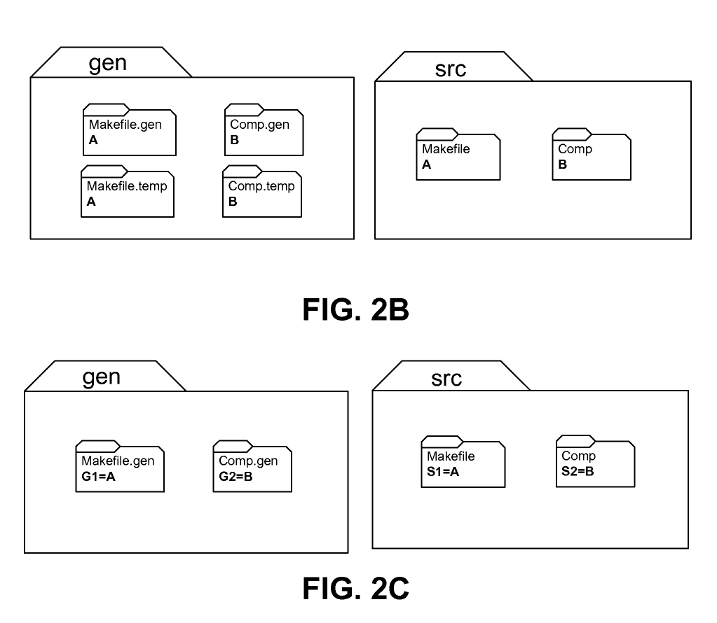

An exemplary structure of the src and gen directories is shown in FIGS. 2A-2C. The src directory contains the src code, or source code, for the components in the model. Artifacts in the source directory structure can be viewed and modified by the user. As such, artifacts in the src directory will include any changes made by a user after the last code generation action. Merge files created in the source directory structure are viewable by the user. The gen directory is a directory created to enable merge avoidance, or minimization, and its directory structure (subdirectories, etc.) is a mirror of the src directory structure. The gen directory is not manipulated by the user.

FIGS. 2A-2C illustrate contents of two storage locations during a first iteration of a software process according to an embodiment of the present invention. The first iteration of the method according to an embodiment of the present invention is different from subsequent iterations. Considering the first iteration on a per-artifact basis, a .temp file is generated in the gen directory structure. The .temp file can be described generally as a current generated artifact. Exemplary .temp artifacts are illustrated in FIG. 2A. For example, an artifact named “Makefile.temp” has a content of A, and an artifact named “Comp.temp” has a content of B.

Since no .gen file exists in a first iteration, as shown in FIG. 2B the .temp file is copied as .gen in the gen directory structure. Also, since no src artifact exists, the .temp file is copied as the user-modifiable artifact in the src directory structure. As shown in FIG. 2B, the .gen and .temp files, as well as the user-modifiable artifacts, all have the same content at this point. As shown in FIG. 2C, at the end of the first iteration, the .temp files are deleted. The contents of the .gen files and the src artifacts are the same as in FIG. 2B, but are now referred to as G1-G2 for the .gen files and S1-S2 for the src artifacts. This notation will be useful in relation to description of further process iterations.

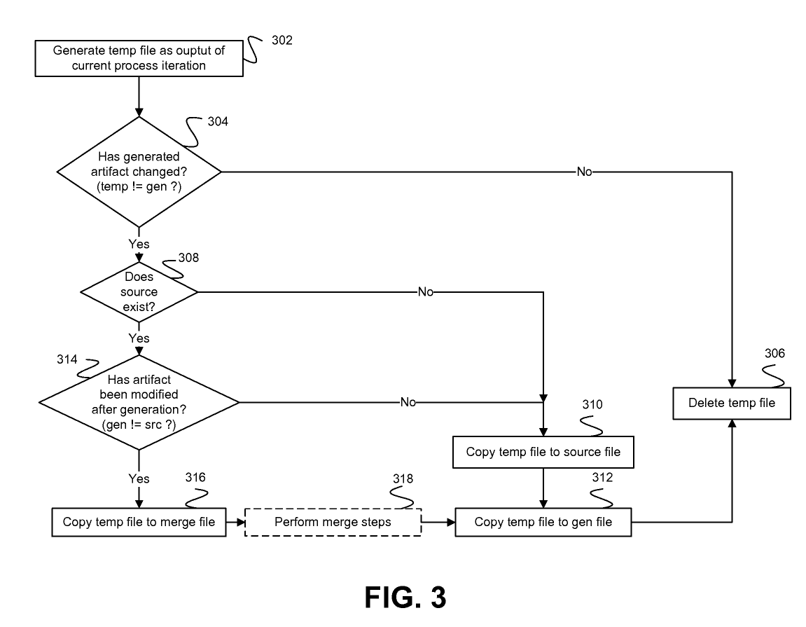

FIG. 3 is a flowchart illustrating a method of detecting a merge condition for an artifact generated by an iterative software process in a computing environment according to an embodiment of the present invention. This flowchart describes the method on a per-artifact basis, for the sake of simplicity. Of course, it is to be understood that this method is repeated for each artifact, as necessary.

In step 302, a .temp file is generated based on the user-modifiable artifact generated by a software process in a current iteration. The .temp file, also referred to as a current generated artifact, is not manipulated by the user, and is used for merge avoidance. Step 304 determines whether a generated artifact has changed. In this embodiment, step 304 includes comparing the .temp file to the gen file, or comparing the current and previous generated artifacts. The notation “temp!=gen” is used in FIG. 3 to represent a condition where the temp file differs from, or is not equal to, the .gen file. In general, an absent file differs from an existing file, so if either file does not exist, the two files are determined to differ. If the .temp file is the same as the .gen file, then this means that the generated artifact has not changed. Since the current and generated artifacts do not differ, any manual changes to the source, or user-modifiable artifact, will not be affected. Therefore, it is irrelevant whether the source has changed, and there is no need to perform a merge operation. The temporary file is then deleted in step 306.

If it is determined in step 304 that the .temp file differs from the .gen file, this means that the generated artifact has changed. The method then proceeds to step 308 to determine whether the source, or user-modifiable artifact, exists. The determination in step 308 only yields a negative determination in a first iteration of the process, and the steps in this flow are those exemplified by the outputs shown in FIGS. 2A-2C. If it is determined in step 308 that the source does not exist, the method proceeds to step 310 in which the .temp file is copied to the source file. After that, the .temp file is also copied to the .gen file in step 312. Finally, the method proceeds to step 306 where the .temp file is deleted.

If the source artifact exists, the method then proceeds to step 314, which determines whether the user-modifiable artifact has been modified after generation. In this embodiment, step 314 includes comparing the .gen file with the source file.

If it is determined in step 314 that the .gen file is the same as the src file, then this means that a source change has not been made outside of the generation process. In this case where the generated artifact has changed, but it has not been modified after generation, the method proceeds to copy the .temp file to the source file in step 310. After that, the .temp file is also copied to the .gen file in step 312. Finally, the method proceeds to step 306 where the .temp file is deleted.

If it is determined in step 314 that the .gen file is not the same as the src file, this means that a source change has been made outside of the generation process, either since the last generation iteration or at some previous point. In this case where the current and generated artifacts are not the same and the user-modifiable artifact has been modified after generation, the .temp file is copied to a .merge file in step 316. This is the first and only scenario in which a .merge file is created, emphasizing the merge minimization aspect of embodiments of the present invention. In an embodiment, the .merge file, or merge artifact, created based on the temp file in step 316 can be stored in the src directory. The merge file is viewable by the user, but generally cannot be modified by the user. In another embodiment, the merge file can be modified by the user.

After step 316, merge steps can be performed in step 318. The merge steps can be performed automatically, manually, or a combination of the two. Step 318 is shown in dotted lines since it can be performed by a known merge function independent of the method according to an embodiment of the present invention. Alternatively, the steps of the merge function can be integrated in embodiments of the present invention. In an embodiment, the merge steps in step 318 include alerting a user to perform a merge operation in response to detection that a merge conflict exists. The detection of merge conflict can be performed by the merge function, and the manner in which the merge conflict is detected is immaterial to the method. Various merge conflict detection schemes are known to those of ordinary skill in the art. The merge steps in step 318 can include automatically performing a merge operation in response to detection that no merge conflict exists. In that case, the merge operation is performed using the merge artifact and the user-modifiable artifact to create an updated user-modifiable artifact. A merge operation is performed in dependence on a set of rules, and can be performed automatically or manually by a user. The actual merge operation that is performed is immaterial to embodiments of the present invention, and any suitable merge operation or merge function can be used to integrate differences between the merge file and the user-modifiable artifact to create an updated user-modifiable artifact, or current user-modifiable artifact. Embodiments of the present invention are performed independent of the actual merge function used.

The merge steps in step 318 can also include deleting the merge file after the merge operation has been performed. After step 318, The method then proceeds to step 312 in which the .temp file is also copied to the gen file. Finally, the method proceeds to step 306 where the .temp file is deleted. In another embodiment, the deletion of the .merge file can be performed after step 312, or after step 306. In still another embodiment, the .temp file deletion can be performed when the file is overwritten on the next iteration.

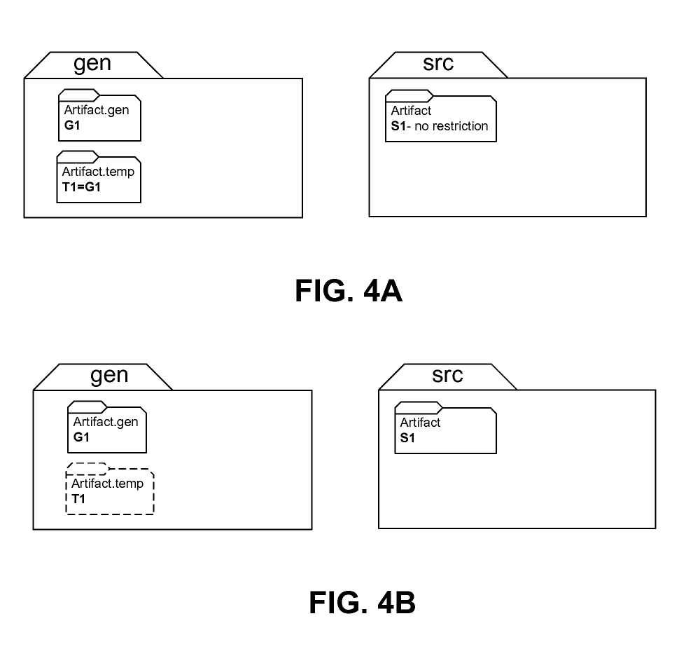

FIGS. 4-6 illustrate exemplary artifacts and their storage locations in various steps and scenarios according to embodiments of the present invention.

FIGS. 4A and 4B illustrate artifacts according to an embodiment of the present invention in the case where current and previous generated artifacts do not differ. In FIG. 4A, which represents the beginning of the current process iteration, the previous generated artifact “Artifact.gen” is shown to have the same content G1 as the current generated artifact “Artifact.temp”. There is no restriction on the content S1 of the user-accessible artifact “Artifact”, since these steps are taken when there is no change in the generated artifact, regardless of whether a source change has occurred. In FIG. 4B, at the end of the current process iteration, the previous generated artifact “Artifact.gen” has the same content G1 as it did at the beginning of the current process, as does the “Artifact” S1. The “Artifact.temp” file is shown in dotted lines, since it is deleted at the end of the current process.

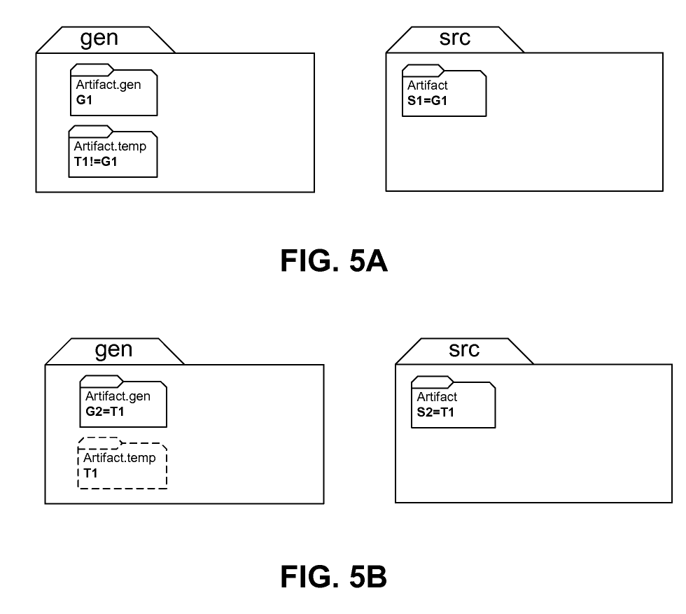

FIGS. 5A and 5B illustrate artifacts according to an embodiment of the present invention in the case where current and previous generated artifacts differ, but there is no source change. In FIG. 5A, which represents the beginning of the current process iteration, the previous generated artifact “Artifact.gen” has a content G1, which differs from the content T1 of the current generated artifact “Artifact.temp”, as represented by T1!=G1. The content of the user-modifiable artifact “Artifact” S1 is the same as the content G1 of the previous generated artifact. In FIG. 5B, at the end of the current process iteration, the content G2 of the previous generated artifact “Artifact.gen” has been changed to the content T1 of the current generated artifact. The content S2 of the user-modifiable artifact “Artifact” is also changed to the content T1 of the current generated artifact. The “Artifact.temp” file is shown in dotted lines, since it is deleted at the end of the current process.

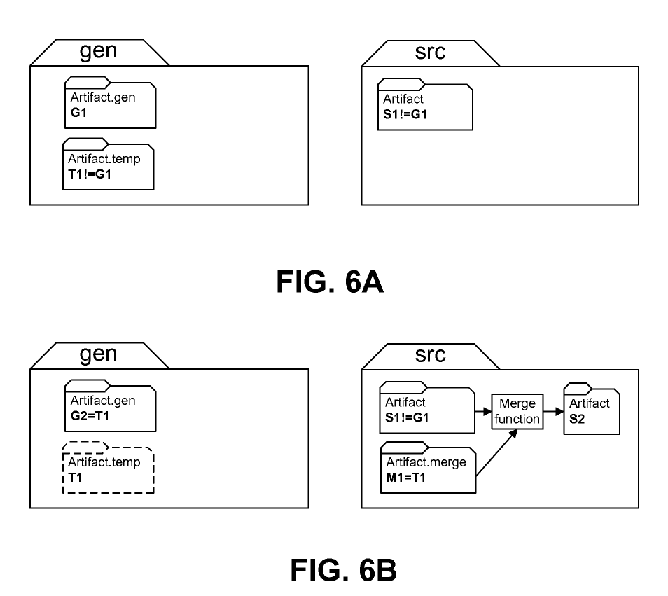

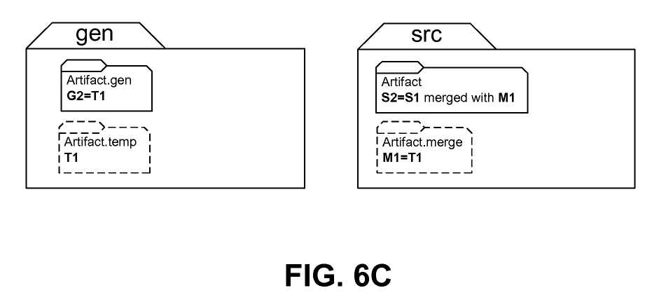

FIGS. 6A, 6B and 6C illustrate artifacts according to an embodiment of the present invention in the case where current and previous generated artifacts differ and a user-modifiable artifact has been modified after generation. In FIG. 6A, which represents the beginning of the current process iteration, the previous generated artifact “Artifact.gen” has a content G1, which differs from the content T1 of the current generated artifact “Artifact.temp”. Similarly, the content of the user-modifiable artifact “Artifact” S1 differs from the content G1 of the previous generated artifact. In FIG. 6B, the merge artifact “Artifact.merge” is created in the src directory with a content M1 equal to the content T1 of the current generated artifact. An updated user-modifiable artifact “Artifact” having a content S2 is created by using a merge function to integrate the differences between “Artifact.merge” and “Artifact”. In FIG. 6C, at the end of the current process iteration, the content G2 of the previous generated artifact “Artifact.gen” has been changed to the content T1 of the current generated artifact. The content S2 of the user-modifiable artifact “Artifact” is also changed to reflect the content S1 merged with M1 as per the merge function. The “Artifact.temp” and “Artifact.merge” files are shown in dotted lines, since they are deleted at the end of the current process.

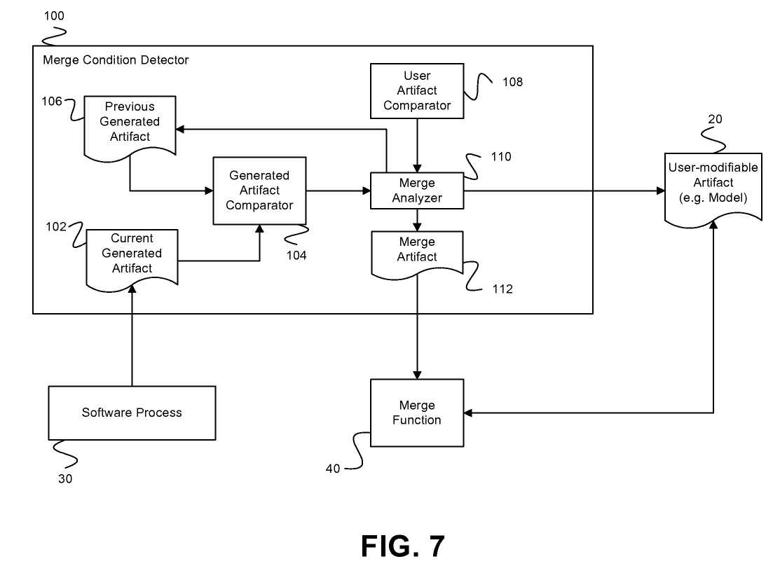

FIG. 7 illustrates an apparatus for detecting a merge condition according to an embodiment of the present invention. The merge condition detector 100 is for detecting a merge condition on a user-modifiable artifact 20 in a computing environment, the user-modifiable artifact being generated by an iterative software process 30. Detecting the merge condition can be described as detecting a requirement to merge different versions of a user-modifiable artifact. A current generated artifact 102 is received from the software process 30 by a generated artifact comparator 104. The generated artifact comparator 104 determines whether current and previous generated artifacts differ by comparing the current generated artifact 102 with the previous generated artifact 106. The previous generated artifact 106 is generated by an output of a previous iteration of the process. A user artifact comparator 108 determines whether a user-modifiable artifact 20 has been modified after generation by comparing the user-modifiable artifact 20 with the previous generated artifact 106. A merge analyzer 110 identifies a merge condition and generate a merge artifact 112 only in response to determination that the current and previous generated artifacts differ and that the user-modifiable artifact has been modified after generation. if a merge artifact is not needed, the merge analyzer 110 updates the user-modifiable artifact 20. The merge analyzer 110 also updates the previous generated artifact 106 at the end of the process iteration. A merge function 40 can perform a merge operation in response to detection, within the merge function, that a merge conflict does not exist. The merge analyzer 110 can control the operation of the merge function 40. The merge artifact can be deleted after the merge operation has been performed.

In summary, in an embodiment of the present invention, a tool maintains current and previous generated artifacts and a user-modifiable artifact and compares these artifacts to perform merge steps. The merge steps can include automatically performing a merge operation when no merge conflict exists. Embodiments of the present invention can be used to generate: application source; application testing code; build make files; documentation; other artifacts; and models (“model transformations” in MDA parlance). These techniques can be applied to the output of an MDA tool, or to the output of other tools or processes. The techniques can be used where the user hand-modifies generated artifacts, or where the generated artifacts are modified other than by hand. In any case, the present invention can be applied to avoiding overwriting of artifact changes.

Moreover, these merge/build minimization techniques can apply to any domain in which: code or other artifacts are generated or produced from one source; artifacts are modified in a separate step; artifacts are iteratively regenerated from the first source; and artifacts can be merged either automatically or with the aid of a file merge tool. Concretely, these techniques are applicable to virtually any Model-Driven Architecture process, including embedded and IT applications, among others.

In the above description, for purposes of explanation, numerous details have been set forth in order to provide a thorough understanding of the present invention. However, it will be apparent to one skilled in the art that these specific details are not required in order to practice the present invention. In other instances, well-known electrical structures and circuits are shown in block diagram form in order not to obscure the present invention. For example, specific details are not provided as to whether the embodiments of the invention described herein are implemented as a software routine, hardware circuit, firmware, or a combination thereof.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium, including magnetic, optical, or electrical storage medium including a diskette, compact disk read only memory (CD-ROM), memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine readable medium may interface with circuitry to perform the described tasks.

Embodiments of the present invention can be provided as an apparatus for detecting a merge condition for a user-modifiable artifact in a computing environment. The user-modifiable artifact is generated by an iterative software process. The apparatus includes a processor and a computer-readable medium. The computer-readable medium stores statements and instructions which, when executed, cause the processor to perform a method of detecting the merge condition. The method performed by the processor can include steps and features as described above in relation to the methods according to embodiments of the present invention.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method of detecting a merge condition for a user-modifiable artifact generated by an iterative software process in a computing environment, comprising:
receiving a current generated artifact as an output of a current iteration of the process;
determining whether the current generated artifact differs from a previous generated artifact by comparing the current and previous generated artifacts, the previous generated artifact being generated by a previous iteration of the process;
determining whether the user-modifiable artifact has been modified after generation by comparing the user-modifiable artifact with the previous generated artifact; and
identifying a merge condition and generating a merge artifact only in response to determination that the current and previous generated artifacts differ and that the user-modifiable artifact has been modified after generation.

2. The method of claim 1 further comprising automatically performing a merge operation in response to detection that no merge conflict exists, the merge operation being performed using the merge artifact and the user-modifiable artifact to create an updated user-modifiable artifact.

3. The method of claim 1 further comprising alerting a user to manually perform a merge operation in response to detection that a merge conflict exists.

4. The method of claim 1 further comprising deleting the merge artifact after a merge operation has been performed.

5. The method of claim 1 wherein generating the merge artifact comprises copying the contents of the current generated artifact to the merge artifact.

6. The method of claim 1 wherein the current generated artifact is deleted after the current iteration of the process, and the previous generated artifact persists after the current iteration of the process.

7. The method of claim 1 further comprising, in response to determination that the current and previous generated artifacts differ, updating the previous generated artifact to comprise the contents of the current generated artifact.

8. The method of claim 1 further comprising, in response to determination that the current and previous generated artifacts differ but the artifact has not been modified after generation, updating the user-modifiable artifact to comprise the contents of the current generated artifact.

9. The method of claim 1 further comprising, if the previous generated artifact does not exist, generating the previous generated artifact based on the current generated artifact.

10. The method of claim 1 further comprising, if the user-modifiable artifact does not exist, generating the user-modifiable artifact based on the current generated artifact.

11. The method of claim 1 wherein the user-modifiable artifact, the current generated artifact, the previous generated artifact and the merge artifact are software artifacts.

12. The method of claim 11 wherein the software artifacts each comprise software code.

13. The method of claim 11 wherein the software artifacts each comprise a model.

14. A computer-readable medium storing statements and instructions which, when executed, cause a processor to perform a method of detecting a merge condition for a user-modifiable artifact in a computing environment, the user-modifiable artifact being generated by an iterative software process, the method comprising:
receiving a current generated artifact as an output of a current iteration of the process;
determining whether the current generated artifact differs from a previous generated artifact by comparing the current and previous generated artifacts, the previous generated artifact being generated by a previous iteration of the process;
determining whether the user-modifiable artifact has been modified after generation by comparing the user-modifiable artifact with the previous generated artifact; and
identifying a merge condition and generating a merge artifact only in response to determination that the current and previous generated artifacts differ and that the user-modifiable artifact has been modified after generation.

15. The computer-readable medium of claim 14 wherein the method further comprises automatically performing a merge operation in response to detection that no merge conflict exists, the merge operation being performed using the merge artifact and the user-modifiable artifact to create an updated user-modifiable artifact.

16. The computer-readable medium of claim 14 wherein the method further comprises alerting a user to manually perform a merge operation in response to detection that a merge conflict exists.

17. The computer-readable medium of claim 14 wherein the method further comprises deleting the merge artifact after a merge operation has been performed.

18. The computer-readable medium of claim 14 wherein, in the method, generating the merge artifact comprises copying the contents of the current generated artifact to the merge artifact.

19. The computer-readable medium of claim 14 wherein, in the method, the current generated artifact is deleted after the current iteration of the process, and the previous generated artifact persists after the current iteration of the process.

20. The computer-readable medium of claim 14 wherein the method further comprises, in response to determination that the current and previous generated artifacts differ, updating the previous generated artifact to comprise the contents of the current generated artifact.

21. The computer-readable medium of claim 14 wherein the method further comprises, in response to determination that the current and previous generated artifacts differ but the artifact has not been modified after generation, updating the user-modifiable artifact to comprise the contents of the current generated artifact.

22. The computer-readable medium of claim 14 wherein the method further comprises, if the previous generated artifact does not exist, generating the previous generated artifact based on the current generated artifact.

23. The computer-readable medium of claim 14 wherein the method further comprises, if the user-modifiable artifact does not exist, generating the user-modifiable artifact based on the current generated artifact.

24. The computer-readable medium of claim 14 wherein the user-modifiable artifact, the current generated artifact, the previous generated artifact and the merge artifact are software artifacts.

25. The computer-readable medium of claim 24 wherein the software artifacts each comprise software code.

26. The computer-readable medium of claim 24 wherein the software artifacts each comprise a model.

27. An apparatus for detecting a merge condition for a user-modifiable artifact in a computing environment, the user-modifiable artifact being generated by an iterative software process, the apparatus comprising:
a generated artifact comparator to determine whether current and previous generated artifacts differ by comparing the current generated artifact with the previous generated artifact, the current generated artifact being received as an output of a current iteration of the process and the previous generated artifact being generated by a previous iteration of the process;
a user artifact comparator to determine whether the user-modifiable artifact has been modified after generation by comparing the user-modifiable artifact with the previous generated artifact; and
a merge analyzer to identify a merge condition and generate a merge artifact only in response to determination that the current and previous generated artifacts differ and that the user-modifiable artifact has been modified after generation.
